(19) United States
(12) Patent Application Publication
(10) Pub. No.: US 2010/0189622 A1
(43) Pub. Date: Jul. 29, 2010

(54) Recovery method of silicon slurry

(76) Inventors: C. W. Lan, Taipei City (TW); Yen-Chih Lin, Taipei City (TW); Teng-Yu Wang, Taipei City (TW); Yi-Der Tai, Taipei City (TW)

Correspondence Address: Jackson Intellectual Property Group PLLC, 106 Starvale Lane, Shipman, VA, 22971, US

(21) Appl. No.: 12/081,120

(22) Filed: Apr. 10, 2008

(30) Foreign Application Priority Data
Apr. 13, 2007 (TW) 96112970

(51) Int. Cl. C01B 33/02

(52) U.S. Cl. 423/348

(57) ABSTRACT

In slicing a crystal bar into silicon wafers, an average of about 40% of silicon would be loss due to the widths of slicing wire saws themselves. The fact that the silicon slurry is discarded or discarded after recovering silicon carbide particles causes a large waste of cost. According to the present invention, the silicon slurry undergoes an acid washing step and a high temperature separation step, wherein the heating temperature is between the melting points of silicon and silicon carbide, and the silicon slurry is resident for an appropriate time, such that the silicon and silicon carbide would be separated to obtain silicon. The present invention could recover the raw material used in solar crystals, further capable of increasing the silicon crystal production and lowering the cost.

### FIELD OF THE INVENTION

The present invention relates to a recovery method of silicon slurry, and more particularly, to a recovery method of silicon slurry, which recovers silicon from the silicon slurry lost in slicing a crystal bar into silicon wafers by removing the impurities from the silicon slurry.

### BACKGROUND OF THE INVENTION

Accompanying with an increasing focus on renewable energy in recent years, the solar industry has grown and developed rapidly. Particularly in Taiwan, it is extremely possible that Taiwan would become the world's first photovoltaic site followed by the semiconductor, panel and diode industries through vertical integration of upstream and downstream supply. During these two years, the need for solar cells has risen considerably since renewable energy policies were motivated in every country, especially in Germany. The shipping quantity of 2005 exceeds 1 GW in a single year so that the lack of silicon raw material causes its high-rising price (above 100$/Kg at present), and this also directly impacts the development of the solar industry. Therefore, low-cost raw materials and recovery of consumed materials would play a key role in positive development of the industry and cost reduction of solar power generation. Additionally, more and more firms joined the solar industry these years in Taiwan, such that the supply of silicon raw material is unable to meet the demand.

After completing the growth of a solar silicon crystal, its crown and tail would be cut first, followed by using a diamond wheel to perform external grinding till its diameter meets the wanted size. The silicon crystal bar is fixed in the crystallographic direction through its flat, then sliced into wafers by a metal slicing wire saw, followed by steps of edge profiling, lapping, polishing and the like to give the required silicon wafers for IC manufacturing process. In the above process, the most easily consumable step is the slicing step, wherein an average of about 40% of silicon would be loss due to the widths of slicing wire saws themselves (kerf loss). The silicon slurry caused by slicing is discarded as sludge, and in view of economics and costs, this would be an incredible waste. Even though diamond wheels have been replaced by wire saws to slice crystal ingots in industry, but the kerf loss is still unavoidable due to their wire width of about 150 gm. A wafer slice would approximately get one lost.

It consumes a large amount of cutting fluids and abrasive fluids in lapping and polishing a wafer. The main compositions of these cutting/abrasive slurries are water, silicon carbide abrasive particles (5-30 μm), further containing lubricating oil with chemical composition, resins for fixing crystal bars and the consumed metal of slicing wire saws (brass as the basis). The function of water is to dilute the abrasive particles and carry away the heat generated by cutting and lapping. The key roles, which cause the cutting/abrasive action, are silicon carbide particles suspended in the slurry. The reason for selecting silicon carbide is owing to its high hardness and low price. In spite of the cheapness of silicon carbide, most people still put emphasis on recovering the silicon carbide from wasted abrasive slurry because it is used in a high volume and takes the most fraction of wasted silicon slurry. Since a large amount of abrasive fluids are utilized in lapping wafers and they cannot be recycled in order to maintain good wafer quality as well as the most portion of these abrasive fluids is silicon carbide and the silicon content is relatively low, thus the recovery of silicon carbide is more simple and beneficial than that of silicon. Moreover, in comparison with silicon powder, some silicon carbide particles have small particle sizes (about 1 micron or less) due to the particle crush by lapping. This would lead to the difficulty of separation. Additionally, the purity required for silicon raw material is very high (6-nine to 7-nine) with allowable impurity levels below 1 ppm. Therefore, the separation of silicon from silicon carbide is quite difficult in terms of technology.

### SUMMARY OF THE INVENTION

In slicing a crystal bar into silicon wafers, an average of about 40% of silicon would be loss due to the widths of slicing wire saws themselves. The fact that the silicon slurry is discarded as sludge or discarded after recovering silicon carbide particles causes a large waste of cost. If the silicon slurry (about 40% of silicon) could be recovered as the raw material for growing silicon crystal bars, the production cost would be lowered. The silicon slurry contains impurities such as lubricating oil or ethylene glycol, the consumed metal of slicing wire saws and the like, besides silicon, water and silicon carbide. Considering the above-mentioned problems, the recovery method of silicon slurry according to the present invention can effectively remove the above impurities to give silicon raw material, which could recover the raw material used in solar crystals, further capable of increasing the silicon crystal production.

In embodiment of the method of the present invention, the recycled sludge first undergoes an acid washing step to remove the metallic materials from the silicon slurry, followed by a high temperature separation step, wherein the heating temperature is between the melting points of silicon and silicon carbide, and the silicon slurry is resident for an appropriate time, such that the silicon would crystallize out and be agglomerated into blocks, almost completely separated from the silicon carbide, then removing the silicon carbide to obtain silicon.

### BRIEF DESCRIPTION OF THE DRAWINGS

FIG. 1 is a flow chart of the main steps in the recovery method of silicon slurry according to the present invention.

FIG. 2 is a schematic diagram of the states of silicon slurry formed after various steps according to the present invention.

### DETAILED DESCRIPTION OF THE PREFERRED EMBODIMENTS

For the purpose of ascertaining all facts pertinent to the present invention, it is illustrated in the following detailed description of the preferred embodiments in coordination with the reference drawings

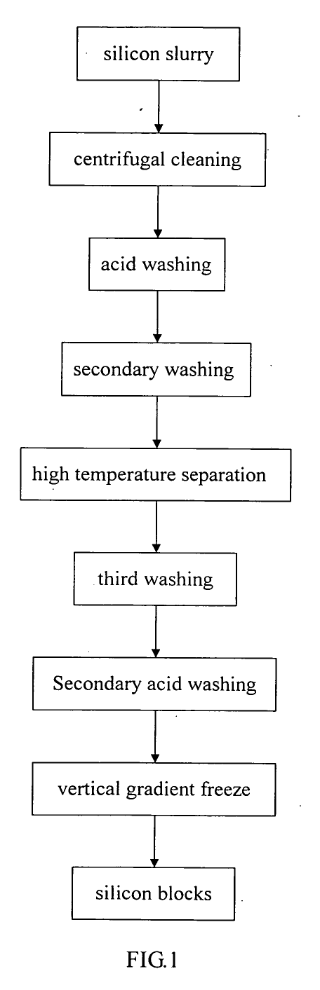

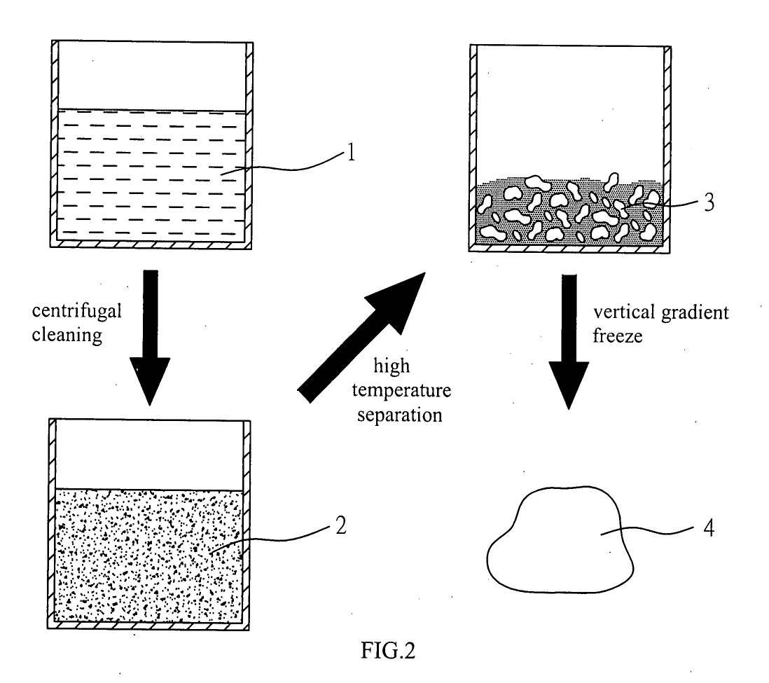

In the recovery method of silicon slurry according to the present invention, when a crystal bar is sliced into silicon wafers, the silicon slurry would form. The main composition of the silicon slurry includes the abraded silicon particles, the silicon carbide particles for cutting, lubricating oil or ethylene glycol, the consumed metal of slicing wire saws, or the unexpected contaminants in this treating process. As shown in FIGS. 1 and 2, the recovery method comprises the following steps.

a. Centrifugal cleaning, in which a cleaner, such as acetone is added to remove the impurities from the silicon slurry and its liquid 1 is separated by centrifugation. The centrifugation can be either batch or continuous type. For example, industrial disc centrifuges can be used for continuous centrifugation, so as to remove the sewage and lubricating oil. The deposited silicon slurry is obtained after centrifugation of the cleaned slurry and the silicon slurry is present in the form of powder 2, as shown in FIG. 2. The water can be removed from the turbid supernatant by distillation for the next rinse. Most of the contaminants in solution state can be removed in this step.
b. Acid washing, in this step, the silicon slurry only contains silicon carbide and silicon particles along with a lot of metal contaminants. The metal contaminants mainly come from the consumed metal of slicing wire saws (e.g. plating copper) and a little fraction of them is some metal ions contained in the solution of the previous cleaning step. These metal contaminants generally adsorb the surface of the silicon crystal in the form of bonding or oxides. By means of acid washing, sulfuric acid, hydrochloric acid or nitric acid would react with the metal of the crystal surface to form soluble complexes dissolved in the solution, then filtered and rinsed to remove the metallic materials. The content of the metal contaminants in the silicon slurry is low, so the cleaning acid can be reused for many times, and it does not increase the production cost too much.
c. Secondary washing for removing organic materials. The silicon slurry after acid washing still contains some organic materials. Although the content of these materials is low, they may be cracked into carbon during a heating process then embedded in the silicon crystal. Therefore, it needs to perform secondary washing with alcohols or ketones, such as ethanol and acetone, to remove organic materials completely. The residue after the filtration in this step is the desired silicon slurry, and the alcohols and ketones can be recycled after distilling the filtrate. Followed by cleaning with alcohols or ketones, the silicon slurry can be rinsed with clean water for one more time to make sure that all solvents are removed.
d. High temperature separation, in which the heating temperature is between the melting points of silicon and silicon carbide, and the melting point of silicon is 1412° C., and the melting point of silicon carbide is 2545° C. . The heating temperature may be from about 1420 to 1500° C., and the silicon slurry is resident for an appropriate time, and the residence time is at least 3 hours. When the heating temperature is from 1420 to 1500° C., above the melting point of silicon, at this time the silicon would crystallize out and be agglomerated into blocks 3, as shown in FIG. 2, and it could be almost completely separated from the silicon carbide.
e. Third washing. After the high temperature separation, the silicon slurry is formed into a plurality of agglomerated blocks of silicon and silicon carbide powders. The silicon carbide powders can be removed by cleaning and then the agglomerated blocks of silicon can be obtained.
f. Secondary acid washing, in which the agglomerated blocks of silicon are collected and sulfuric acid, hydrochloric acid or nitric acid is employed to react with the metal of the crystal surface to form soluble complexes dissolved in the solution by means of acid washing, then filtered and rinsed to remove the metallic materials.
g. Vertical gradient freeze, in which the trace amount of residual silicon carbide is removed and the metallic materials could be segregated and purified so as to form silicon blocks 4 of larger size.

Furthermore, a silicon dissolution step can be carried out between step b and step c by adding hydrofluoric acid for cleaning to accelerate the dissolution of silica existed in the silicon slurry.

Hence, the silicon slurry (about 40% of silicon) could be recovered as the raw material for growing silicon crystal bars in use of the recovery method of silicon slurry according to the present invention. Thus, the production cost could be lowered, and water, silicon carbide, the impurities such as lubricating oil, ethylene glycol or the consumed metal of slicing wire saws and the like contained in the silicon slurry are effectively removed except silicon to give silicon raw material, further capable of recovering the raw material used in solar crystals and increasing the silicon crystal production.

The examples and drawings has been described above are the preferred embodiments of the present invention only, it is not intended to limit the scope of the present invention, hence all similar or equivalent changes and modifications made according to the claims and specification fall within the scope of the claims.

What is claimed is:

1. A recovery method of silicon slurry comprising the following steps of:
a. acid washing, in which a pickling agent is added to remove the metallic materials from the silicon slurry, and at this time the silicon slurry is mainly comprised of silicon and silicon carbide;
b. high temperature separation, in which the heating temperature is between the melting points of silicon and silicon carbide, and the silicon slurry is resident for an appropriate time, such that the silicon and silicon carbide are separated, then removing the silicon carbide to obtain silicon.

2. The recovery method of silicon slurry as described in claim 1, wherein a centrifugal cleaning step is further carried out before the acid washing step, and a cleaner is added and centrifugal separation of liquid is conducted for removing the impurities from the silicon slurry in the centrifugal cleaning step.

3. The recovery method of silicon slurry as described in claim 1, wherein the pickling agent is sulfuric acid, hydrochloric acid or nitric acid.

4. The recovery method of silicon slurry as described in claim 1, wherein a secondary washing step is further carried out after the acid washing step.

5. The recovery method of silicon slurry as described in claim 4, wherein organic materials can be washed out by alcohols or ketones, then rinsed by clean water in the secondary washing step.

6. The recovery method of silicon slurry as described in claim 5, wherein the alcohol is ethanol and the ketone is acetone.

7. The recovery method of silicon slurry as described in claim 4, wherein a hydrofluoric acid cleaning step is added between the acid washing step and the secondary washing step to accelerate the dissolution of silica existed in the silicon slurry.

8. The recovery method of silicon slurry as described in claim 1, wherein the cleaner is acetone.

9. The recovery method of silicon slurry as described in claim 1, wherein the heating temperature is from 1420 to 1500° C. in the high temperature separation step.

10. The recovery method of silicon slurry as described in claim 1, wherein the residence time is at least 3 hours in the high temperature separation step.

11. The recovery method of silicon slurry as described in claim 1, wherein a third washing step is further carried out after the high temperature separation step.

12. The recovery method of silicon slurry as described in claim 11, wherein a secondary acid washing step is added further carried out after the third washing step.

13. The recovery method of silicon slurry as described in claim 11, wherein a vertical gradient freeze step is further carried out after the third washing step.
